(19) United States
(12) Patent Application Publication
(10) Pub. No.: US 2023/0158604 A1
(43) Pub. Date: May 25, 2023

(54) LASER PROCESSING APPARATUS AND RELATIONSHIP DETERMINATION METHOD

(71) Applicant: Nagoya Institute of Technology, Nagoya-Shi, Aichi (JP)

(72) Inventors: Fumihiro Itoigawa, Nagoya-Shi, Aichi (JP); Osamu Konda, Nagoya-Shi, Aichi (JP); Sho Fujiwara, Nagoya-Shi, Aichi (JP); Shotaro Yasuda, Nagoya-Shi, Aichi (JP)

(21) Appl. No.: 17/761,221

(22) PCT Filed: Mar. 4, 2021
(86) PCT No.: PCT/JP2021/008385

§ 371 Date: Mar. 17, 2022

(51) Int. Cl. B23K 26/08; B23K 26/03; B23K 26/36

(52) U.S. Cl. CPC B23K 26/083; B23K 26/032; B23K 26/36

(57) ABSTRACT

Provided is a laser processing apparatus configured to machine a corner portion of a sample by causing the corner portion to relatively approach a laser, the laser being emitted such that an optical axis of the laser extends in a predetermined direction, the corner portion being formed by a plurality of adjacent surfaces of the sample, the laser processing apparatus including: a detection unit provided at a position at least outside an irradiation region of the laser, the irradiation region extending in a tubular shape in a plan view intersecting the optical axis, the detection unit being configured to detect intensity of light reaching the position; approach control means for controlling an actuator relatively displacing the sample along a direction intersecting the optical axis such that the sample relatively approaches the optical axis; value acquisition means for acquiring the intensity of the light defined as a value detected by the detection unit in a predetermined positional relationship in which a tip of the corner portion has reached the irradiation region; and relationship determination means for determining a positional relationship between the laser and the sample based on the intensity of the light detected by the detection unit while the sample relatively approaches the optical axis.

### TECHNICAL FIELD

The present invention relates to a laser processing apparatus that performs laser machining.

### BACKGROUND ART

In recent years, a laser machining apparatus has been proposed in which a cylindrical irradiation region extending in the optical axis direction of a laser is displaced in a direction intersecting the optical axis to form a machining surface on the surface side of a sample through which the irradiation region passes (Patent Document 1). Machining by means of this apparatus is an excellent machining method in that mechanical damage can be reduced and a machining surface can be smoothly formed as compared with mechanical machining methods.

### CITATION LIST

### Patent Document

Patent Document 1: JP 6562536 B2

### SUMMARY OF THE INVENTION

### Problem to be Solved by the Invention

This type of machining method is also used in machining a corner portion in a sample formed by a plurality of adjacent surfaces, examples of which include a cutting tool having a corner portion formed by a rake surface and a flank surface. Specifically, laser irradiation is performed such that the optical axis extends along the direction of spread of the rake surface or the flank surface and the laser is displaced to form a new rake or flank surface in the corner portion as a machining surface.

As for this apparatus, machining is conducted when the laser irradiation region and the corner portion overlap. Accordingly, for efficient machining, a positional relationship is desirable in which the tip of the corner portion reaches the irradiation region (e.g. the outer periphery of the irradiation region or the optical axis in the irradiation region) prior to the machining. However, making such a positional relationship determination requires many additional components for that purpose only (e.g. laser and sensor) and entails a problematic increase in required cost.

The invention has been made to solve such a problem, and an object of the invention is to provide a technique with which the positional relationship between a laser and a corner end can be determined at a lower cost than in the related art in a laser machining apparatus.

### Means for Solving Problem

A first aspect for solving the above problem is a laser processing apparatus configured to perform laser machining on a corner portion of a sample by causing the corner portion to relatively approach a laser, the laser being emitted such that an optical axis of the laser extends in a predetermined direction, the corner portion being formed by a plurality of adjacent surfaces of the sample, the laser processing apparatus including: a detection unit provided at a position at least outside an irradiation region of the laser, the irradiation region extending in a tubular shape in a plan view intersecting the optical axis, the detection unit being configured to detect intensity of light reaching the position; approach control means for controlling an actuator relatively displacing the sample along a direction intersecting the optical axis such that the sample relatively approaches the optical axis; value acquisition means for acquiring the intensity of the light defined as a value detected by the detection unit in a predetermined positional relationship in which a tip of the corner portion has reached the irradiation region; and relationship determination means for determining a positional relationship between the laser and the sample based on the intensity of the light detected by the detection unit while the sample relatively approaches the optical axis. When the detection unit detects the intensity of the light as a value the same as the value acquired by the value acquisition means or within a predetermined threshold range, the relationship determination means determines that the predetermined positional relationship is established.

This aspect may be as described in the following second aspect.

In the second aspect, the approach control means controls the actuator such that the sample relatively approaches the optical axis until the relationship determination means determines that the tip of the corner portion is in the predetermined positional relationship in which the tip has reached the irradiation region.

These aspects may be as described in the following third aspect.

In the third aspect, in a case where the detection unit detects the intensity of the light as a value outside the predetermined threshold range with the value acquired by the value acquisition means, the relationship determination means determines that the tip of the corner portion is not in the predetermined positional relationship in which the tip has reached the irradiation region, and the approach control means controls the actuator such that the sample relatively approaches the optical axis until the relationship determination means determines that the tip is in the positional relationship after the relationship determination means determines that the tip of the corner portion is not in the predetermined positional relationship in which the tip has reached the irradiation region.

The second and third aspects may be as described in the following fourth aspect.

In the fourth aspect, the actuator control by the approach control means, the light intensity acquisition by the value acquisition means, and the positional relationship determination by the relationship determination means are performed each time the corner portion is machined with the laser.

Each of the above aspects may be as described in the following fifth aspect.

In the fifth aspect, the detection unit is provided at the position at least outside the irradiation region in the plan view intersecting the optical axis with the position in a region opposite to a light source of the laser in a case where a space extending along the optical axis is divided into two by the sample.

A sixth aspect for solving the above problem is a position determination method including: a detection procedure of detecting intensity of light reaching a position at least outside an irradiation region of a laser, the irradiation region extending in a tubular shape in a plan view intersecting an optical axis of the laser having the optical axis extending in a predetermined direction; an approach control procedure of controlling an actuator relatively displacing a sample where a corner portion is formed by a plurality of adjacent surfaces of the sample along a direction intersecting the optical axis with the corner portion directed to the laser side such that the sample relatively approaches the optical axis; a value acquisition procedure of acquiring the intensity of the light defined as a value detected by the detection unit in a predetermined positional relationship in which a tip of the corner portion has reached the irradiation region; and a relationship determination procedure of determining a positional relationship between the laser and the sample based on the intensity of the light detected by the detection procedure while the sample relatively approaches the optical axis. When detecting the intensity of the light as a value the same as the value acquired in the value acquisition procedure or within a predetermined threshold range in the detection procedure, determining that the predetermined positional relationship is established.

### Effect of the Invention

According to each of the aspects, the positional relationship between the laser and the sample can be determined based on a light intensity detection result simply by being capable of detecting the light intensity at a position outside the laser irradiation region. Accordingly, it is not necessary to provide a number of additional device configurations for the determination and the cost of positional relationship determination can be reduced.

### BRIEF DESCRIPTION OF DRAWINGS

FIG. 1 is a block diagram illustrating an overall configuration of a laser machining apparatus;

FIG. 2 is a block diagram illustrating a configuration of an irradiation unit;

FIG. 3 is a diagram illustrating a positional relationship between a laser irradiation region and a detection unit;

FIG. 4 is a flowchart illustrating a machining processing procedure;

FIG. 5 is a diagram illustrating an energy distribution in a laser;

FIG. 6 is a flowchart illustrating a relationship determination processing procedure; and

FIG. 7 is a graph illustrating a light intensity transition corresponding to a sample displacement amount.

### MODE(S) FOR CARRYING OUT THE INVENTION

An embodiment for carrying out the invention will be described in detail with reference to the drawings.

(1) Apparatus Configuration

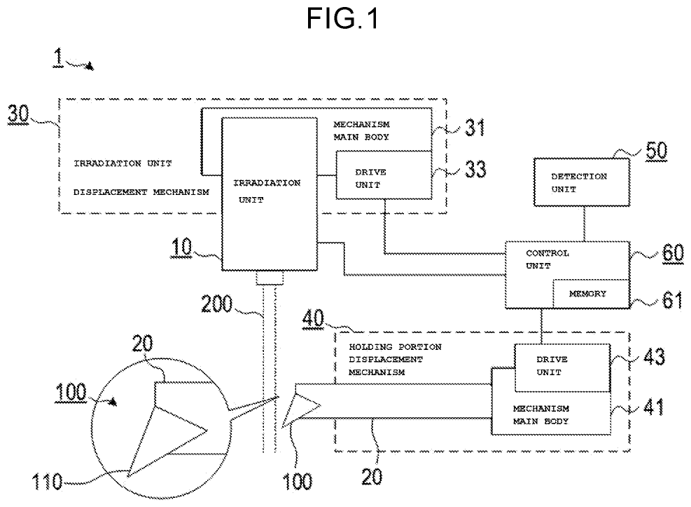

As illustrated in FIG. 1, a laser machining apparatus 1 includes an irradiation unit 10 performing laser irradiation such that an optical axis extends in a predetermined direction (up-down direction in FIG. 1), a holding portion 20 for holding a sample 100, an irradiation unit displacement mechanism 30 for displacing the irradiation unit 10 with respect to the sample 100, a holding portion displacement mechanism 40 for displacing the holding portion 20 with respect to the laser, a detection unit 50 detecting the intensity of light at a predetermined position, and a control unit 60 controlling the operation of the entire laser machining apparatus 1.

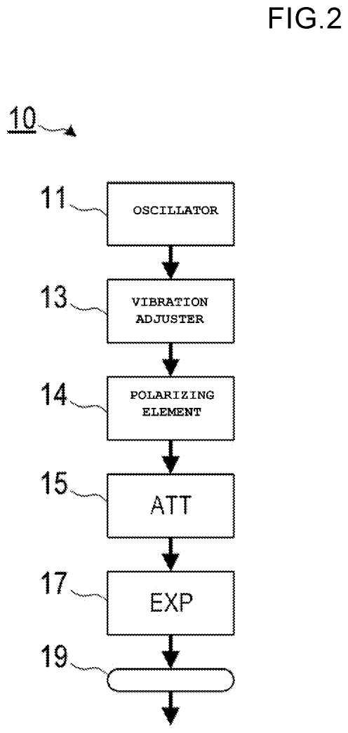

As illustrated in FIG. 2, the irradiation unit 10 includes, for example, an oscillator 11 outputting a pulsed laser, a vibration adjuster 13 adjusting the order of the frequency of the laser, a polarizing element 14 performing polarization state adjustment, an attenuator (ATT) 15 performing laser output adjustment, and a beam expander (EXP) 17 for laser diameter adjustment. The irradiation unit 10 is configured such that the laser passing through the components is output via an optical lens 19 and performs laser irradiation with the optical axis directed in a predetermined direction (Z-axis direction in the present embodiment). An Nd:YAG pulsed laser is used for the oscillator 11.

The above configuration includes the single optical lens 19. An alternative configuration may include a set of optical lenses disposed at predetermined intervals and a mechanism for adjusting the distance between the optical lenses.

The holding portion 20 is a rod-shaped member extending in a direction intersecting the optical axis of the laser (left-right direction in FIG. 1) and is configured so as to be capable of holding the sample 100 at the tip of the holding portion 20. The sample 100 is held in a positional relationship in which an end portion of the sample 100 protrudes from the tip of the holding portion 20.

The irradiation unit displacement mechanism 30 includes a mechanism main body 31 as an actuator displaced in a predetermined direction with the irradiation unit 10 attached and a drive unit 33 operating the mechanism main body 31 based on a command from the outside. In the present embodiment, the mechanism main body 31 is configured to displace the irradiation unit 10 in a direction intersecting the optical axis of the laser (direction from the front to the back of the paper surface in FIG. 1).

The holding portion displacement mechanism 40 includes a mechanism main body 41 as an actuator displaced in a predetermined direction with the holding portion 20 attached and a drive unit 43 operating the mechanism main body 41 based on a command from the outside. In the present embodiment, the mechanism main body 41 is configured to displace the holding portion 20 in the direction in which the holding portion 20 extends.

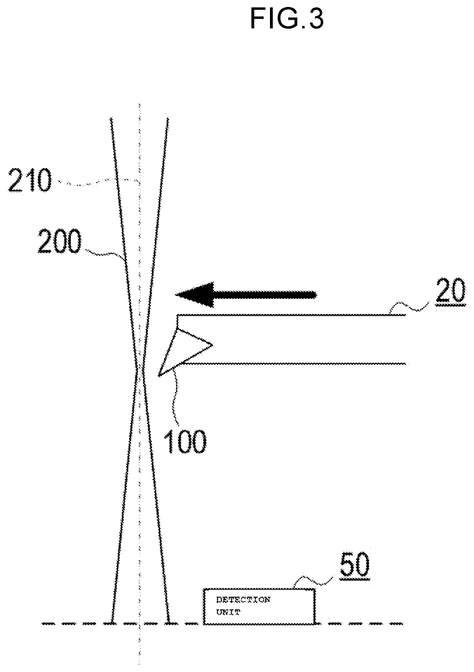

As illustrated in FIG. 3, the detection unit 50 is an optical sensor provided at a position at least outside an irradiation region 200 when viewed from a plane intersecting an optical axis 210 (plane of the broken line in FIG. 3) with the position in the region opposite to the irradiation unit 10 in a case where the space extending along the optical axis 210 is divided into two at the position of the sample 100 (region below the holding portion 20 in FIG. 3). The detection unit 50 detects the intensity of light that reaches this position (hereinafter, also referred to as “light intensity”). In the present embodiment, a line sensor in which a plurality of light receiving elements are disposed in a direction away from the optical axis 210 is adopted as the detection unit 50. The detection unit 50 is disposed at a position that diffracted light is capable of reaching with sufficient intensity in the relationship determination processing to be described later.

The control unit 60 is a computer controlling, for example, the laser irradiation that is performed by the irradiation unit 10, the displacement of the irradiation unit 10 that is performed by the irradiation unit displacement mechanism 30, and the displacement of the holding portion 20 that is performed by the holding portion displacement mechanism 40 by means of control commands to the respective parts.

As for the sample 100, a corner portion 110 is formed by a plurality of adjacent surfaces. In the present embodiment, the sample 100 is a cutting tool made of cemented carbide, one surface of the tool is a rake surface, and the other is a flank surface.

By installing the corner portion 110 of the sample 100 toward the laser irradiation region 200 side, the surface formed by the corner portion 110 is disposed along the optical axis 210.

As for the laser machining apparatus 1 configured as described above, a machining surface can be formed on the corner portion 110 by performing laser irradiation such that the optical axis 210 extends along the plane direction formed by the corner portion 110 and displacing the laser.

(2) Procedure of Processing by Control Unit 60

(2-1) Machining Processing

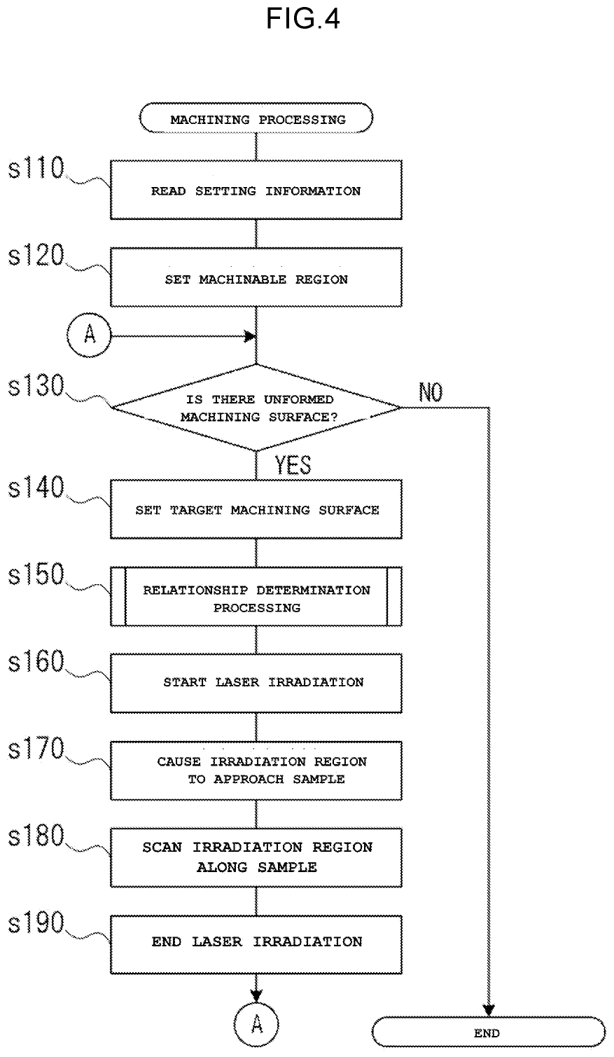

Hereinafter, the procedure of “machining processing” that the control unit 60 executes with a program stored in a built-in memory 61 will be described with reference to FIG. 4. This machining processing is executed after the sample 100 is held by the holding portion 20 and positioned and is started when a start command is received from an interface (operation device or communication device, not illustrated).

This machining processing is performed after the holding portion 20 holding the sample 100 is positioned at a predetermined reference position and is started when the start command is received from the interface (operation device or communication device, not illustrated). Here, with the holding portion 20 positioned, the tip of the corner portion 110 in the sample 100 reaches the irradiation region 200 in terms of positional relationship. Specifically assumed as the positional relationship is, for example, the tip of the corner portion 110 overlapping the outer periphery of the irradiation region 200, overlapping the irradiation region 200 by a predetermined range, or reaching the optical axis 210.

When this machining processing is started, first, machining processing setting information pre-stored in the built-in memory 61 is read (s110). This setting information is information preset by a user and includes an output P0 [w] of the laser emitted by the irradiation unit 10, a machining threshold Pth [w] corresponding to the material properties of the sample 100 installed in the holding portion 20, and coordinate information defining each of one or more machining surfaces to be formed on the sample 100.

The laser output is determined such that a machinable region having an energy distribution equal to or higher than the machining threshold Pth [w] required for the laser machining of the sample 100 is formed inside the irradiation region 200, which extends in a tubular shape along the optical axis 210, in the laser. The laser output is an output level corresponding to the material properties of the sample 100. In addition, the coordinate information determines the position of the machining surface in the sample 100 as three-dimensional coordinates with reference to a predetermined origin.

The length of the machinable region along the optical axis direction is required to be longer than at least that on the machining surface of the sample 100. Accordingly, the output of the laser is set in view of the relationship with the coordinate information such that this length is realized. Specifically, the output level P0 of the laser is a value larger than the machining threshold Pth (P0>Pth).

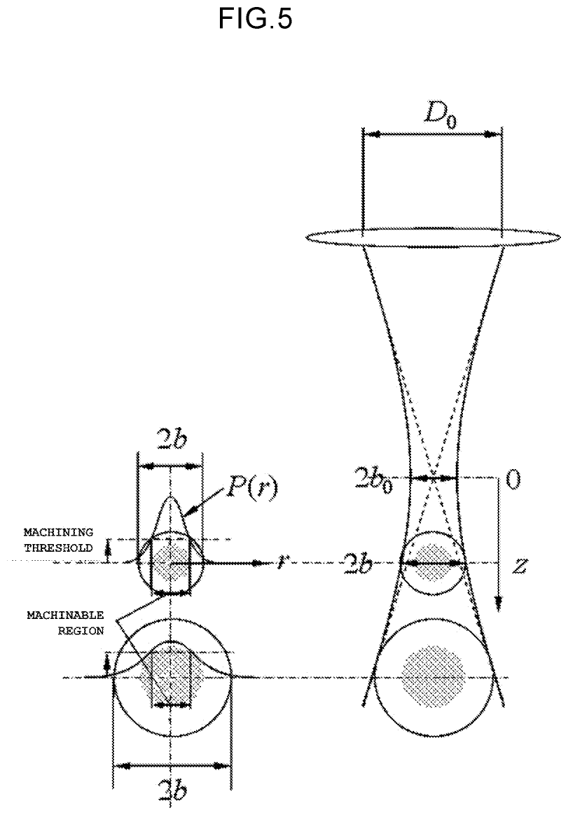

Next, the machinable region is set based on the setting information read in s110 (s120). Here, an energy distribution P(r) at each position on the optical axis of the laser is calculated based on the laser output P0 [w] and the machining threshold Pth [w] among the setting information read in s110, and then a tubular region formed by connecting a planar region with a predetermined radius rth, which has an energy distribution equal to or higher than the machining threshold Pth, along the optical axis is specified (see FIG. 5). Then, the radius rth in this region is specified as a parameter that defines the machinable region.

It has been experimentally confirmed that this machinable region changes from a linear tubular shape to a constricted tubular shape decreasing in diameter toward the focal position as the laser output PO increases. In other words, the outer periphery of the machinable region changes from a linear shape to a curved shape as the laser output P0 increases. Accordingly, as for the laser output P0, a value corresponding to a shape required for the machining surface is selectively included in the setting information.

Next, it is checked whether or not there is an unformed machining surface (s130). Here, it is determined that there is an unformed machining surface in a case where the coordinate information that has not been referred to since the start of this machining processing is left in the coordinate information in the setting information read in s110.

In a case where it is determined in s130 that there is an unmachined machining surface (s130: YES), any coordinate information that is not referred to in the subsequent processing is extracted and the machining surface defined by this coordinate information is set as a target machining surface to be formed in the subsequent processing (s140).

Next, the relationship determination processing to be described later is executed (s150). Here, it is determined whether or not the tip of the corner portion 110 reaches the irradiation region 200 in the predetermined positional relationship at this point in time and the positional relationship between the tip of the corner portion 110 and the irradiation region 200 is corrected such that such a positional relationship is achieved.

Next, laser irradiation by means of the irradiation unit 10 is started (s160). Here, the control unit 60 commands the irradiation unit 10 to perform laser irradiation by which the machinable region set in s120 can be formed and the laser irradiation by means of the irradiation unit 10 is started with this command received. In this manner, the laser is emitted such that the optical axis 210 extends in a predetermined direction (up-down direction in FIG. 1 in the present embodiment).

Next, the holding portion displacement mechanism 40 causes the sample 100 to approach the irradiation region 200 in the laser emitted by the irradiation unit 10 (s170). Here, a control command is given to the holding portion displacement mechanism 40 such that the sample 100 approaches the irradiation region 200 side. In response to this control command, the holding portion displacement mechanism 40 displaces the sample 100 until the sample 100 and the machinable region overlap.

The sample 100 and the machinable region overlap by causing the irradiation region 200 to approach the sample 100 until the distance between the optical axis of the laser and the machining surface of the sample 100 (distance along the left-right direction in FIG. 1 in the present embodiment) corresponds to the radius rth defining the machinable region of the irradiation region 200 based on the radius rth defined in s120 and the coordinate information on the machining surface set in s140.

Next, the irradiation unit displacement mechanism 30 performs scanning with the irradiation region 200 in the laser emitted by the irradiation unit 10 along the corner portion 110 of the sample 100 (s180). Here, a control command is given to the irradiation unit displacement mechanism 30 such that the irradiation unit 10 is displaced along the corner portion 110. In response to this control command, the irradiation unit displacement mechanism 30 starts displacement from a predetermined reference position, displaces the irradiation unit 10 until the irradiation region 200 passes through the entire machining surface, and then returns to the reference position. The scanning of the corner portion 110 by means of the irradiation region 200 here is repeated a plurality of times.

Through s170 to s180 in this manner, the corner portion 110 of the sample 100 is machined by the machinable region of the irradiation region 200.

After s180, the laser irradiation by means of the irradiation unit 10 started in s160 ends (s190). Here, the control unit 60 commands the irradiation unit 10 to end the irradiation and the irradiation unit 10 ends the laser irradiation with this command received.

After finishing s190, the process returns to s130. Subsequently, s130 to s190 are carried out until there is no unmachined machining surface. Subsequently, this machining processing ends in a case where it is determined in s130 that there is no unmachined machining surface (s130: NO).

(2-2) Relationship Determination Processing

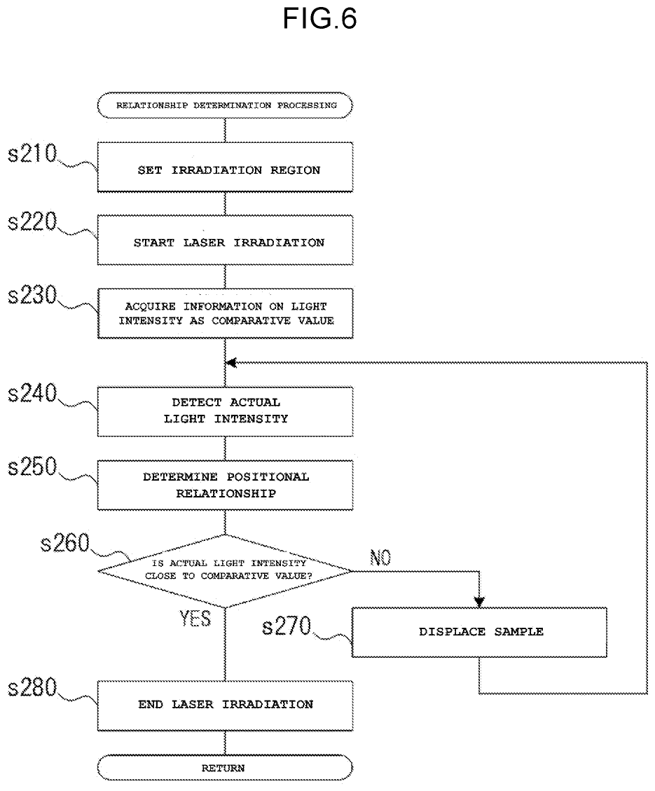

The procedure of “relationship determination processing” executed by s150 of the machining processing will be described below with reference to FIG. 6.

When this relationship determination processing is started, the irradiation region 200 is set first (s210). Here, a value smaller than the machining threshold Pth is set as the laser output level P0 based on the setting information read in s110 (P0<Pth).

Next, laser irradiation by means of the irradiation unit 10 is started (s220). Here, the control unit 60 commands the irradiation unit 10 to perform laser irradiation by which the irradiation region 200 set in s210 can be formed and the laser irradiation by means of the irradiation unit 10 is started with this command received. In this manner, the laser is emitted such that the optical axis 210 extends in a predetermined direction (up-down direction in FIG. 1 in the present embodiment).

Next, information indicating a predetermined light intensity is acquired as a comparative value used in the subsequent processing (s230). Acquired here is information indicating the light intensity defined as being detected by the detection unit 50 in a case where the tip of the corner portion 110 reaches the irradiation region 200 in terms of positional relationship with respect to the laser irradiation region 200 set in s210.

In the present embodiment, the light intensity actually detected by the detection unit 50 in a case where the positional relationship between the irradiation region 200 and the tip of the corner portion 110 is changed with respect to each of the irradiation regions 200 having a plurality of assumed patterns is pre-recorded as information in the built-in memory 61 and the information indicating the light intensity as the comparative value is acquired by reading the information matching in positional relationship from the information recorded in this manner. The information read here matches the current positional relationship defined by the initial positional relationship at a point in time when the holding portion 20 is positioned (e.g. positional relationship of the tip of the corner portion 110 overlapping the outer periphery of the irradiation region 200, overlapping the irradiation region 200 by a predetermined range, or reaching the optical axis 210) and the amount of displacement of the sample 100 in the machining processing (s170 in particular).

In the present embodiment, not only the total value or the average value of the light intensities (W) respectively output from the light receiving elements of the line sensor adopted as the detection unit 50 but also the distribution along the disposition direction of the light receiving element in the line sensor (value of each light receiving element position) are detected and recorded as the light intensity in each positional relationship.

Next, the light intensity detected by the detection unit 50 is acquired (s240). Here, not only the total value or the average value of the light intensities (W) respectively output from the light receiving elements of the line sensor adopted as the detection unit 50 but also the distribution along the disposition direction of the light receiving element in the line sensor (value of each light receiving element position) are detected as the actual light intensity in the current positional relationship.

Next, the positional relationship between the laser and the sample 100 is determined based on the light intensity acquired in s230 and s240 (s250). Here, based on the actual light intensity acquired in s240 being the same as the light intensity that is the comparative value acquired in s230 or within a predetermined threshold range, it is determined that the tip of the corner portion 110 reaches the irradiation region 200 in the predetermined positional relationship at that point in time. “Predetermined positional relationship” here means that the positional relationship between the tip of the corner portion 110 and the irradiation region 200 matches the initial positional relationship at a point in time when the holding portion 20 is positioned.

In a case where the light intensity is a value of each light receiving element position in the line sensor, the light intensities at the same position are compared and it is checked whether or not all the values are the same or within a predetermined threshold range.

Here, the actual light intensity being the same as the light intensity that is the comparative value or within a predetermined threshold range, that is, the actually detected light intensity being the same as or close to the light intensity assumed in the same positional relationship means a state where the machining of the corner portion 110 has not been sufficiently carried out in the machining processing executed so far (machining being yet to be performed in the present embodiment) or a state where the positional relationship is corrected in the process to be described later.

The actual light intensity being outside the predetermined threshold range of the light intensity that is the comparative value, that is, the actually detected light intensity not being close to the light intensity assumed in the same positional relationship means that the machining of the corner portion 110 has been sufficiently carried out in the machining processing executed so far. In this state, the positional relationship between the irradiation region 200 and the tip of the corner portion 110 is changed as a result of the tip of the corner portion 110 retracting toward the outside of the irradiation region 200, and thus the actual light intensity is outside the predetermined threshold range of the light intensity that is the comparative value.

Next, in a case where the actual light intensity is not close to the light intensity that is the comparative value as a result of the determination by s250 (s260: NO), the holding portion displacement mechanism 40 causes the sample 100 to approach the irradiation region 200 in the laser emitted by the irradiation unit 10 (s270). Here, a control command is given to the holding portion displacement mechanism 40 such that the sample 100 approaches the irradiation region 200 side. In response to this control command, the holding portion displacement mechanism 40 displaces the sample 100 by a predetermined unit distance. The unit distance in this displacement is sufficiently smaller than the amount of displacement of the sample 100 in the machining processing (s170 in particular).

After finishing s270, the process returns to s240. Subsequently, s240 to s270 are repeated until it is determined that the actual light intensity is the same as or close to the light intensity that is the comparative value. In this manner, in this relationship determination processing, the sample 100 approaches the optical axis 210 after the first determination that the actual light intensity is not the same as or close to the light intensity that is the comparative value, and thus the positional relationship between the laser and the sample 100 is gradually corrected. As a result, the positional relationship between the tip of the corner portion 110 and the irradiation region 200 matches the initial positional relationship at a point in time when the holding portion 20 is positioned.

In a case where it is determined as a result of the determination by s250 that the actual light intensity is the same as or close to the light intensity that is the comparative value (s260: YES), the laser irradiation by means of the irradiation unit 10 started in s220 ends (s280). Here, the control unit 60 commands the irradiation unit 10 to end the irradiation and the irradiation unit 10 ends the laser irradiation with this command received.

In this manner, after finishing s280, the relationship determination processing ends and the process returns to the machining processing.

s230 described above is the value acquisition means in the invention, s240 is the detection procedure in the invention, s260 and s270 are the approach control means and the approach control procedure in the invention, and s250 is the position determination means and the position determination procedure in the invention.

(3) Modification Examples

Although an embodiment of the invention has been described above, the invention is not limited to the above embodiment. It is a matter of course that various forms can be taken insofar as the forms belong to the technical scope of the invention.

For example, in the configuration exemplified in the above embodiment, the sample 100 side is displaced along a direction intersecting the optical axis 210. In an alternative configuration, the optical axis 210 side (that is, laser) may be displaced with respect to the sample 100.

In the configuration exemplified in the above embodiment, the relationship determination processing is executed by the control unit 60 of the laser machining apparatus 1. In an alternative configuration, this relationship determination processing may be executed by an apparatus different from the laser machining apparatus 1. It is conceivable that the apparatus for this purpose includes the irradiation unit 10, the holding portion 20, the holding portion displacement mechanism 40, the detection unit 50, and the control unit 60 that executes the relationship determination processing.

In the configuration exemplified in the above embodiment, the light intensity that is a comparative value is acquired by reading pre-recorded information in s230 of the relationship determination processing. In an alternative configuration, the light intensity that is a comparative value may be acquired as a value calculated from parameters such as the energy distribution in the laser irradiation region 200, the positional relationship between the detection unit 50 and the corner portion 110, and the shape of the corner portion 110.

In the configuration exemplified in the above embodiment, the relationship determination processing is executed and the positional relationship between the laser and the sample 100 is determined every time a machining surface is formed on the sample 100 in the machining processing. However, the timing of determination of the positional relationship between the laser and the sample 100 is not limited thereto and it is conceivable to determine the positional relationship at, for example, each scan of the sample 100 with the irradiation region 200. Conceivable in this case is a configuration in which the relationship determination processing is executed before or after the scan in s180.

In addition, the positional relationship between the laser and the sample 100 may be determined during the actual machining in the machining processing. Conceivable in this case is a configuration in which the relationship determination processing is executed in parallel during the scan in s180.

In addition, the timing of determination of the positional relationship between the laser and the sample 100 may be irrelevant to the machining processing. In this case, the relationship determination processing may be executed at any timing with a start command received.

In the configuration exemplified in the above embodiment, the actual light intensity is compared to a comparative value in determining the positional relationship in the relationship determination processing. In an alternative configuration, the time-axis transitions of the actual light intensity and the light intensity that is a comparative value may be compared in determining the positional relationship.

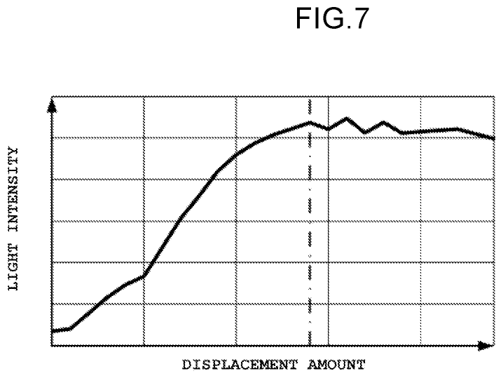

The following is a specific example, in which “positional relationship in which the tip of the corner portion 110 reaches the optical axis 210” is adopted as the initial positional relationship at a point in time when the holding portion 20 is positioned. s240 to s270 of the relationship determination processing are carried out using the light intensity in the process in which the tip of the corner portion 110 reaches the optical axis 210 from the outside of the irradiation region 200 as a comparative value. It has been experimentally confirmed that a section where the light intensity increases at a certain rate or more (side to the left of the one-dot chain line in FIG. 7) and a section where the rate of increase is less than a certain rate (side to the right of the one-dot chain line in FIG. 7) arrive in order as illustrated in FIG. 7 after the tip of the corner portion 110 reaches and overlaps the irradiation region 200 in this process and the tip of the corner portion 110 reaches the optical axis 210 when the latter section arrives. Accordingly, in this case, it is determined that the tip of the corner portion 110 reaches the irradiation region 200 in the predetermined positional relationship at that point in time based on the actual light intensity being the same as the light intensity that is a comparative value or within a predetermined threshold range in terms of the degree of increase.

(4) Actions and Effects

In the above embodiment, the positional relationship between the laser and the sample 100 can be determined based on a light intensity detection result simply by being capable of detecting the light intensity at a position outside the laser irradiation region 200. Accordingly, it is not necessary to provide a number of additional device configurations for the determination and the cost of positional relationship determination can be reduced.

In the laser machining apparatus 1 of the above embodiment, the positional relationship with the irradiation region 200 can be determined and corrected in real time in parallel with the machining of the sample 100.

### INDUSTRIAL APPLICABILITY

The invention can be used in determining a laser-sample positional relationship at a low cost without providing a number of additional device configurations.

### EXPLANATIONS OF LETTERS OR NUMERALS

1 LASER MACHINING APPARATUS

10 IRRADIATION UNIT

11 OSCILLATOR

13 VIBRATION ADJUSTER

14 POLARIZING ELEMENT

15 ATTENUATOR (ATT)

17 BEAM EXPANDER (EXP)

19 OPTICAL LENS

20 HOLDING PORTION

30 IRRADIATION UNIT DISPLACEMENT MECHANISM

31 MECHANISM MAIN BODY

33 DRIVE UNIT

40 HOLDING PORTION DISPLACEMENT MECHANISM

41 MECHANISM MAIN BODY

43 DRIVE UNIT

50 DETECTION UNIT

60 CONTROL UNIT

61 BUILT-IN MEMORY

100 SAMPLE

110 CORNER PORTION

200 IRRADIATION REGION

210 OPTICAL AXIS

1. A laser processing apparatus configured to perform laser machining on a corner portion of a sample by causing the corner portion to relatively approach a laser, the laser being emitted such that an optical axis of the laser extends in a predetermined direction, the corner portion being formed by a plurality of adjacent surfaces of the sample, the laser processing apparatus comprising:
a detection unit provided at a position at least outside an irradiation region of the laser, the irradiation region extending in a tubular shape in a plan view intersecting the optical axis, the detection unit being configured to detect intensity of light reaching the position;
approach control means for controlling an actuator relatively displacing the sample along a direction intersecting the optical axis such that the sample relatively approaches the optical axis;
value acquisition means for acquiring the intensity of the light defined as a value detected by the detection unit in a predetermined positional relationship in which a tip of the corner portion has reached the irradiation region; and
relationship determination means for determining a positional relationship between the laser and the sample based on the intensity of the light detected by the detection unit while the sample relatively approaches the optical axis,
wherein, when the detection unit detects the intensity of the light as a value the same as the value acquired by the value acquisition means or within a predetermined threshold range, the relationship determination means determines that the predetermined positional relationship is established.

2. The laser processing apparatus according to claim 1, wherein the approach control means controls the actuator such that the sample relatively approaches the optical axis until the relationship determination means determines that the tip of the corner portion is in the predetermined positional relationship in which the tip has reached the irradiation region.

3. The laser processing apparatus according to claim 1, wherein
in a case where the detection unit detects the intensity of the light as a value outside the predetermined threshold range with the value acquired by the value acquisition means, the relationship determination means determines that the tip of the corner portion is not in the predetermined positional relationship in which the tip has reached the irradiation region, and
the approach control means controls the actuator such that the sample relatively approaches the optical axis until the relationship determination means determines that the tip is in the positional relationship after the relationship determination means determines that the tip of the corner portion is not in the predetermined positional relationship in which the tip has reached the irradiation region.

4. The laser processing apparatus according to claim 3, wherein the actuator control by the approach control means, the light intensity acquisition by the value acquisition means, and the positional relationship determination by the relationship determination means are performed each time the corner portion is machined with the laser.

5. The laser machining apparatus according to claim 1, wherein the detection unit is provided at the position at least outside the irradiation region in the plan view intersecting the optical axis with the position in a region opposite to a light source of the laser in a case where a space extending along the optical axis is divided into two by the sample.

6. A position determination method comprising:
a detection procedure of detecting intensity of light reaching a position at least outside an irradiation region of a laser, the irradiation region extending in a tubular shape in a plan view intersecting an optical axis of the laser having the optical axis extending in a predetermined direction;
an approach control procedure of controlling an actuator relatively displacing a sample where a corner portion is formed by a plurality of adjacent surfaces of the sample along a direction intersecting the optical axis with the corner portion directed to the laser side such that the sample relatively approaches the optical axis;
a value acquisition procedure of acquiring the intensity of the light defined as a value detected by the detection procedure in a predetermined positional relationship in which a tip of the corner portion has reached the irradiation region; and
a relationship determination procedure of determining a positional relationship between the laser and the sample based on the intensity of the light detected by the detection procedure while the sample relatively approaches the optical axis,
wherein, when detecting the intensity of the light as a value the same as the value acquired in the value acquisition procedure or within a predetermined threshold range in the detection procedure, determining that the predetermined positional relationship is established.

7. The laser processing apparatus according to claim 2, wherein
in a case where the detection unit detects the intensity of the light as a value outside the predetermined threshold range with the value acquired by the value acquisition means, the relationship determination means determines that the tip of the corner portion is not in the predetermined positional relationship in which the tip has reached the irradiation region, and
the approach control means controls the actuator such that the sample relatively approaches the optical axis until the relationship determination means determines that the tip is in the positional relationship after the relationship determination means determines that the tip of the corner portion is not in the predetermined positional relationship in which the tip has reached the irradiation region.

8. The laser processing apparatus according to claim 2, wherein the actuator control by the approach control means, the light intensity acquisition by the value acquisition means, and the positional relationship determination by the relationship determination means are performed each time the corner portion is machined with the laser.

9. The laser machining apparatus according to claim 2, wherein the detection unit is provided at the position at least outside the irradiation region in the plan view intersecting the optical axis with the position in a region opposite to a light source of the laser in a case where a space extending along the optical axis is divided into two by the sample.

10. The laser machining apparatus according to claim 3, wherein the detection unit is provided at the position at least outside the irradiation region in the plan view intersecting the optical axis with the position in a region opposite to a light source of the laser in a case where a space extending along the optical axis is divided into two by the sample.

11. The laser machining apparatus according to claim 4, wherein the detection unit is provided at the position at least outside the irradiation region in the plan view intersecting the optical axis with the position in a region opposite to a light source of the laser in a case where a space extending along the optical axis is divided into two by the sample.

12. The laser machining apparatus according to claim 7, wherein the detection unit is provided at the position at least outside the irradiation region in the plan view intersecting the optical axis with the position in a region opposite to a light source of the laser in a case where a space extending along the optical axis is divided into two by the sample.

13. The laser machining apparatus according to claim 8, wherein the detection unit is provided at the position at least outside the irradiation region in the plan view intersecting the optical axis with the position in a region opposite to a light source of the laser in a case where a space extending along the optical axis is divided into two by the sample.
